(19) United States
(12) Patent Application Publication
(10) Pub. No.: US 2026/0039518 A1
(43) Pub. Date: Feb. 5, 2026

(54) MULTI-LEVEL PULSE AMPLITUDE MODULATION RECEIVING DEVICE AND ALL TRANSITION PHASE DETECTOR THEREOF

(71) Applicant: National Yang Ming Chiao Tung University, Hsinchu City (TW)

(72) Inventors: Wei-Zen CHEN, Hsinchu County (TW); Yun-Le LIN, Hsinchu City (TW)

(21) Appl. No.: 19/283,198

(22) Filed: Jul. 28, 2025

(30) Foreign Application Priority Data
Aug. 2, 2024 (TW) 113129037

(51) Int. Cl. H04L 27/04

(52) U.S. Cl. CPC H04L 27/04

(57) ABSTRACT

A multi-level pulse amplitude modulation (PAM) signal receiving device comprises an all transition phase detector (ATPD) for receiving a data signal. The ATPD comprises a first-layer comparator structure to compare the data signal with critical voltages of the first-layer comparator structure to generate an error information, and a second-layer comparator structure connected to the first-layer comparator structure in series to compare reset speeds of the first-layer comparator structure to generate a data information. A decoder coupled to the ATPD for decoding the data information to generate a binary code. A least mean square engine coupled to the ATPD for updating the critical voltages based on the error information.

### RELATED APPLICATIONS

This application claims priority to Taiwanese Application Serial Number 113129037, filed Aug. 2, 2024, which is herein incorporated by reference in its entirety.

### BACKGROUND

### Technical Field

The present disclosure relates to a receiving device. More particularly, the present disclosure relates to a multi-level pulse amplitude modulation (PAM) receiving device.

### Description of Related Art

Pulse-amplitude modulation (PAM) technology is the mainstream technology for high-speed transmission interfaces. The advantage of the PAM technology is that one symbol can represent multiple bits of information under the same channel loss, thereby improving Data transfer rate. However, when deserializing data at the receiving end, the PAM technology also requires more hardware to decode the signal, which causes the load effect of the front-end circuit is so large that limits system bandwidth and increases the power consumption. To overcome this problem, a provided technology is to reduce the phase detection density of the receiver to reduce the hardware burden in exchange for lower energy consumption. However, this technology also sacrifices the system performance, such as the receiver's frequency tracking capability, noise tolerance, and locking speed.

Therefore, there is a need for a pulse amplitude modulation receiving device that does not affect the system bandwidth without increasing power consumption.

### SUMMARY

Some aspects of the present disclosure are to provide a multi-level pulse amplitude modulation (PAM) signal receiving device, comprising an all transition phase detector (ATPD) to receive a data signal. The all transition phase detector further comprises a first-layer comparator structure comparing the data signal with critical voltages of the first-layer comparator structure to generate an error information, and a second-layer comparator structure connected to the first-layer comparator structure in series for comparing reset speeds of the first-layer comparator structure to generate a data information. A decoder is coupled to the all transition phase detector for decoding the data information to generate a binary code. A least mean square engine is coupled to the all transition phase detector for updating the critical voltages based on the error information.

In some embodiments, the critical voltages include a first critical voltage, a second critical voltage, a third critical voltage and a fourth critical voltage. The first-layer comparator structure further comprises a first comparator, wherein a first input terminal of the first comparator receives the data signal, and a second input terminal of the first comparator receives the first critical voltage; a second comparator, wherein a first input terminal of the second comparator receives the data signal, and a second input terminal of the second comparator receives the second critical voltage; a third comparator, wherein a first input terminal of the third comparator receives the data signal, and a second input terminal of the third comparator receives the third critical voltage; and a fourth comparator, wherein a first input terminal of the fourth comparator receives the data signal, and a second input terminal of the fourth comparator receives the fourth critical voltage.

In some embodiments, the first critical voltage is +3 volts, the second critical voltage is +1 volt, the third critical voltage is −1 volt and the fourth threshold voltage is −3 volts.

In some embodiments, the second-layer comparator structure further comprises a fifth comparator, wherein a first input terminal of the fifth comparator is coupled to an output terminal of the second comparator, and a second input terminal of the fifth comparator is coupled to an output terminal of the first comparator, wherein the fifth comparator compares reset speeds of the first comparator and the second comparator; a sixth comparator, wherein a first input terminal of the sixth comparator is coupled to an output terminal of the third comparator, and a second input terminal of the sixth comparator is coupled to an output terminal of the second comparator, wherein the sixth comparator compares reset speeds of the second comparator and the third comparator; and a seventh comparator, wherein a first input terminal of the seventh comparator is coupled to an output terminal of the fourth comparator, and a second input terminal of the seventh comparator is coupled to an output terminal of the third comparator, wherein the seven comparator compares reset speeds of the third comparator and the fourth comparator.

In some embodiments, the multi-level pulse amplitude modulation signal receiving device is a PAM-4 signal receiving device.

In some embodiments, Boolean function of the binary code generated by the decoder decoding the data information is

$$MSB [ n ] = {T}_{0} [ n ] \cdot {T}_{- 2} [ n ] , LSB [ n ] = ( {T}_{2} [ n ] ⊕ {T}_{0} [ n ] ) ’ \cdot {T}_{- 2} [ n ]$$

the T₂[n] is an output signal generated by the fifth comparator comparing the reset speeds of the first comparator and the second comparator, the T₀[n] is an output signal generated by the sixth comparator comparing the reset speeds of the second comparator and the third comparator, and the T₋₂[n] is an output signal generated by the seventh comparator comparing the reset speeds of the third comparator and the fourth comparator.

Some aspects of the present disclosure are to provide an all transition phase detector (ATPD) installed in a multi-level pulse amplitude modulation signal receiving device. The all transition phase detector comprises a first-layer comparator structure for comparing a multi-level pulse amplitude modulation signal with critical voltages of a plurality of comparators in the first-layer comparator structure to generate an error information, and a second-layer comparator structure connected to the first-layer comparator structure in series for comparing reset speeds of the comparators in the first-layer comparator structure to generate a data information. The data information includes a binary code carried by the multi-level pulse amplitude modulation signal, and the error information is used to correct the critical voltages of the plurality of comparators.

In some embodiments, the critical voltages include a first critical voltage, a second critical voltage, a third critical voltage and a fourth critical voltage. The comparators in the first-layer comparator structure further comprises a first comparator, wherein a first input terminal of the first comparator receives the multi-level pulse amplitude modulation signal, and a second input terminal of the first comparator receives the first critical voltage; a second comparator, wherein a first input terminal of the second comparator receives the multi-level pulse amplitude modulation signal, and a second input terminal of the second comparator receives the second critical voltage; a third comparator, wherein a first input terminal of the third comparator receives the multi-level pulse amplitude modulation signal, and a second input terminal of the third comparator receives the third critical voltage; and a fourth comparator, wherein a first input terminal of the fourth comparator receives the multi-level pulse amplitude modulation signal, and a second input terminal of the fourth comparator receives the fourth critical voltage.

In some embodiments, the first critical voltage is +3 volts, the second critical voltage is +1 volt, the third critical voltage is −1 volt and the fourth threshold voltage is −3 volts.

In some embodiments, the second-layer comparator structure further comprises a fifth comparator, wherein a first input terminal of the fifth comparator is coupled to an output terminal of the second comparator, and a second input terminal of the fifth comparator is coupled to an output terminal of the first comparator, wherein the fifth comparator compares reset speeds of the first comparator and the second comparator; a sixth comparator, wherein a first input terminal of the sixth comparator is coupled to an output terminal of the third comparator, and a second input terminal of the sixth comparator is coupled to an output terminal of the second comparator, wherein the sixth comparator compares reset speeds of the second comparator and the third comparator; and a seventh comparator, wherein a first input terminal of the seventh comparator is coupled to an output terminal of the fourth comparator, and a second input terminal of the seventh comparator is coupled to an output terminal of the third comparator, wherein the seven comparator compares reset speeds of the third comparator and the fourth comparator.

In some embodiments, the multi-level pulse amplitude modulation signal receiving device is a PAM-4 signal receiving device.

In some embodiments, a decoder is coupled to the all transition phase detector for decoding the data information to generate a binary code carried by the multi-level pulse amplitude modulation signal.

In some embodiments, Boolean function of the binary code generated by the decoder decoding the data information is

$$MSB [ n ] = {T}_{0} [ n ] \cdot {T}_{- 2} [ n ] , LSB [ n ] = ( {T}_{2} [ n ] ⊕ {T}_{0} [ n ] ) ’ \cdot {T}_{- 2} [ n ]$$

the T₂[n] is an output signal generated by the fifth comparator comparing the reset speeds of the first comparator and the second comparator, the T₀[n] is an output signal generated by the sixth comparator comparing the reset speeds of the second comparator and the third comparator, and the T₋₂[n] is an output signal generated by the seventh comparator comparing the reset speeds of the third comparator and the fourth comparator.

In some embodiments, a least mean square engine is coupled to the all transition phase detector for updating the critical voltages of the comparators based on the error information.

In some embodiments, Boolean function for correcting the critical voltages of the comparators by the least mean square engine is

$$L {V}_{1} [ n + 1 ] = L {V}_{1} [ n ] + μ \cdot {E}_{1} [ n ]$$

$$L {V}_{3} [ n + 1 ] = L {V}_{3} [ n ] + μ \cdot {E}_{3} [ n ]$$

$${LV}_{- 1} [ n + 1 ] = L {V}_{- 1} [ n ] + μ \cdot {E}_{- 1} [ n ]$$

$${LV}_{- 3} [ n + 1 ] = L {V}_{- 3} [ n ] + μ \cdot {E}_{- 3} [ n ]$$

wherein the LV₁[n], the LV₃[n], the LV₋₁[n] and the LV₋₃[n] are the critical voltages of the first comparator, the second comparator, the third comparator and the fourth comparator respectively before updating; the LV₁[n+1], the LV₃[n+1], the LV₋₁[n+1], and the LV₋₃[n+1] are the critical voltages of the first comparator, the second comparator, the third comparator and the fourth comparator respectively after updating; u is a weight for updating the critical voltages; and the E₁[n], the E₃[n], the E₋₁[n] and the E₋₃[n] are output signals generated by comparing the multi-level pulse amplitude modulation signal with the LV₁[n], the LV₃[n], the LV₋₁[n] and the LV₋₃[n] of the first comparator, the second comparator, the third comparator and the fourth comparator respectively.

Accordingly, the all transition phase detector (ATPD) for a multi-level PAM signal receiving device in the present disclosure includes a two-layer comparator structure. The first-layer of the two-layer comparator structure performs voltage level comparison to compare the multi-level PAM signal with the critical voltage level. The second layer of the two-layer comparator structure performs reset speed comparison to compare the reset speeds of comparators in the first layer of the two-layer comparator structure for decoding the signal, adjusting the coefficient of the equalizer, and tracking the signal level. Accordingly, the load effect of the two-layer demodulation structure in this present application is 4×. Compared with the traditional PAM-4 demodulator, the load effect on the front-end circuit of the receiving device is reduced to 57%.

### BRIEF DESCRIPTION OF THE DRAWINGS

The disclosure can be more fully understood by reading the following detailed description of the embodiment, with reference made to the accompanying drawings as follows:

FIG. 1 illustrates a schematic diagram of a four-bit pulse amplitude modulation (PAM-4) receiving device according to a preferred embodiment of the present invention.

FIG. 2 illustrates a schematic diagram of an all transition phase detector (ATPD) according to a preferred embodiment of the present invention.

FIG. 3 illustrates a comparator structure diagram of an all transition phase detector (ATPD) according to a preferred embodiment of the present invention.

FIG. 4A illustrates a frequency locking speed comparison diagram between a pulse amplitude modulation receiving device using the all transition phase detector of the present invention and a pulse amplitude modulation receiving device using a conventional phase detector.

FIG. 4B illustrates a comparison diagram of the noise tolerance bandwidth between a pulse amplitude modulation receiving device using the all transition phase detector of the present invention and a pulse amplitude modulation receiving device using a conventional phase detector.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

The use of ordinals such as first, second and third does not necessarily imply a ranked sense of order, but rather may only distinguish between multiple instances of an act or structure.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. In the present disclosure, “connected” or “coupled” may refer to “electrically connected” or “electrically coupled.” “Connected” or “coupled” may also refer to operations or actions between two or more elements.

Traditionally, demodulators for four-bit pulse amplitude modulation (PAM-4) signals mostly use the middle values of the signal amplitude as the critical voltages. Taking the four-bit pulse amplitude modulation demodulator of (+3, +1,−1,−3) as an example, at least three comparators with critical voltages of (+2, 0,−2) are required. When performing amplitude tracking and phase detection, it also requires four additional comparators with critical voltages of (+3, +1,−1,−3). That is, the number of the comparators is seven in traditional PAM-4 demodulator. Therefore, the load effect of the front-end circuit of receiving device can be estimated to be 7×, where X is the comparator load. Therefore, in order to reduce the load effect of receiving device, this present application uses a two-layer demodulation structure to demodulate the four-bit pulse amplitude modulation signal, in which the first layer of the two-layer demodulation structure includes four comparators with critical voltages of (+3, +1,−1,−3) to obtain phase error and amplitude error information immediately so as to quickly perform loop convergence, including phase and frequency adjustment, level convergence, and adaptive equalizer adjustment, of the receiver. Moreover, by determining the time delay of the latch circuit in the first layer of the two-layer demodulation structure, the second-layer of the two-layer demodulation structure demodulates the pulse amplitude signal according to the determining result. Accordingly, the load effect of the two-layer demodulation structure in this present application is 4×. Compared with the traditional four-bit pulse amplitude modulation demodulator, the load effect on the front-end circuit of the receiving device is reduced to 57%. In addition, because the first layer of the two-layer demodulation structure may obtain phase error and amplitude error information in real time, the present application can achieve all transition phase detection function, which improves the frequency tracking capability, noise tolerance capability, and locking speed of the receiver.

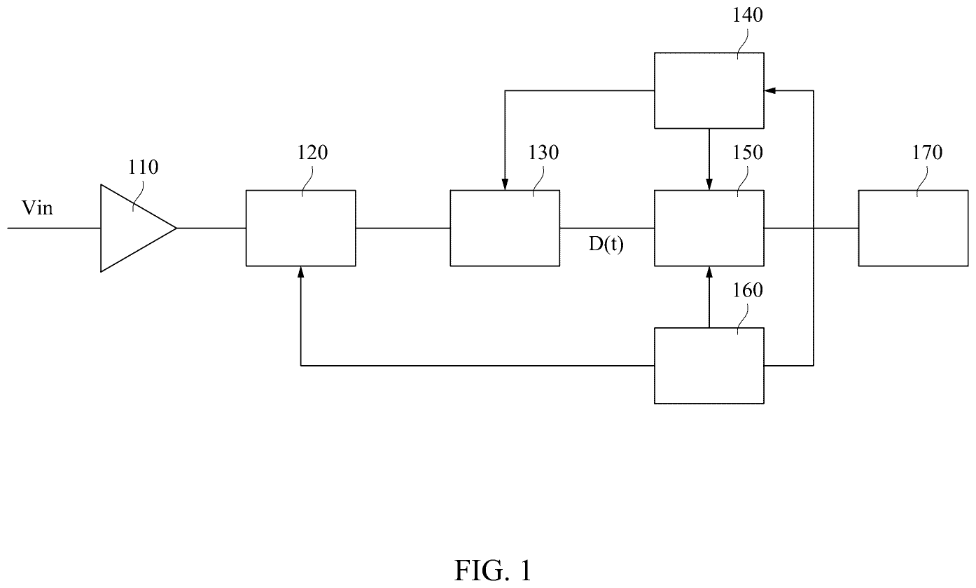

FIG. 1 illustrates a schematic diagram of a four-bit pulse amplitude modulation (PAM-4) receiving device according to a preferred embodiment of the present invention. The PAM-4 receiving device 100 includes a front-end amplifier 110, a sampling and holding circuit 120, an equalizer 130, a least mean square (LMS) engine 140, an all transition phase detector (ATPD) 150, an data recovery circuit 160 and a decoder 170.

In some embodiments, the front-end amplifier 110 is used to receive and amplify a PAM-4 signal Vin. A PAM-4 signal will present four possible DC level voltages within a data time. The sampling and holding circuit 120 is coupled to the front-end amplifier 110 to sample and hold the amplified PAM-4 signal according to the data time to output a sampled and held signal. The equalizer 130 is coupled to the sampling and holding circuit 120 and performs signal compensation on the sampled and held signal to generate a data signal D(t). The ATPD 150 is coupled to the equalizer 130. The ATPD 150 includes a two-layer comparator structure. The first layer of the two-layer comparator structure compares the data signal D(t) and the threshold voltage to generate an error information E_{3,1,-1,-3}[n]. The second-level of the two-layer comparator structure compares the reset speed of the first layer of the two-layer comparator structure to generate data information T_{2,0,-2}[n] of the data signal D(t). The decoder 170 is coupled to the ATPD 150 for decoding the data information T_{2,0,-2}[n] to generate a binary code represented by the data signal D(t). In an embodiment, the binary code is the code carried by the PAM-4 signal in the sampling data time. The least mean square (LMS) engine 140 and the data recovery circuit 160 are coupled to the ATPD 150 to correct the phase and frequency of the critical voltage and the clock signal based on the error information E_{3,1,-1,-3}[n]. n.

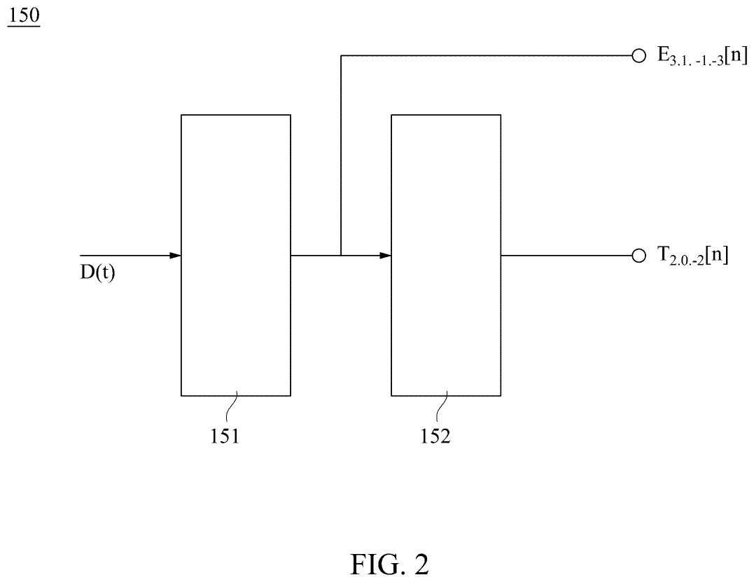

FIG. 2 illustrates a schematic diagram of an all transition phase detector (ATPD) according to a preferred embodiment of the present invention. In some embodiments, the ATPD 150 of the present invention is a two-layer comparator structure including a first-layer comparator structure 151 and a second-layer comparator structure 152. The first-layer comparator structure 151 is connected to the second-layer comparator structure 152 in series. The first-layer comparator structure 151 receives the data signal D(t) output by the equalizer 130, and compares the data signal D(t) with the critical voltage of the first-layer comparator structure 151 to generate an error information E_{3,1,-1,-3}[n]. The second-level comparator structure 152 compares the reset speed of the first-layer comparator structure 151 to generate data information T_{2,0,-2}[n] of the data signal D(t).

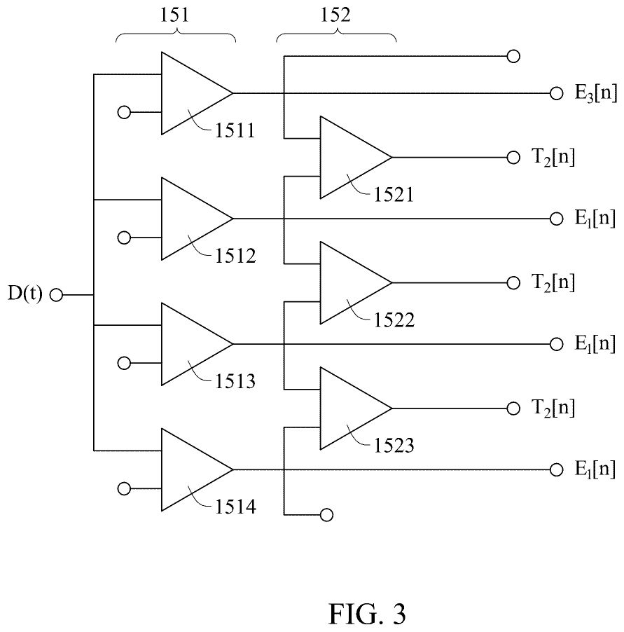

FIG. 3 illustrates a comparator structure diagram of an all transition phase detector (ATPD) according to a preferred embodiment of the present invention. In some embodiments, the first-layer comparator structure 151 includes a first comparator 1511, a second comparator 1512, a third comparator 1513 and a fourth comparator 1514. In some embodiments, the first input terminals, such as the positive input terminals, of the first comparator 1511, the second comparator 1512, the third comparator 1513 and the fourth comparator 1514 are used to receive the data signal D(t) to perform level detection on the data signal D(t) to generate error information E_{3,1,-1,-3}[n]. Because the PAM-4 signal will have four possible DC level voltages within one data time. Therefore, the second input terminal, such as the negative input terminal, of the first comparator 1511 receives +3 volt as the critical voltage. The second input terminal, such as the negative input terminal, of the second comparator 1512 receives +1 volt as the critical voltage. The second input terminal, such as the negative input terminal, of the third comparator 1513 receives-1 volt as the critical voltage. The second input terminal, such as the negative input terminal, of the fourth comparator 1514 receives-3 volt as the critical voltage.

In some embodiments, if the voltage of the data signal D(t) is greater than +3 volt, the first comparator 1511 will generate the output signal E₃[n] of 1 after comparing the data signal D(t) with the critical voltage of +3 volt. The second comparator 1512 generates an output signal E₁[n] of 1 after comparing the data signal D(t) with the critical voltage of +1 volt. The third comparator 1513 will generate an output signal E₋₁[n] of 1 after comparing the data signal D(t) with the critical voltage of −1 volt. The fourth comparator 1514 will generate an output signal E₋₃[n] of 1 after comparing the data signal D (t) with the critical voltage of −3 volt. Then, the output signals, E₃[n], E₁[n], E₋₁[n] and E₋₃[n], form an error information E_{3,1,-1,-3}[n] of 1111.

In another embodiment, if the voltage of the data signal D(t) is between +1 volt and −1 volt, the first comparator 1511 compares the data signal D(t) with the critical voltage of +3 volt to generate the output signal E₃[n] of 0. The second comparator 1512 compares the data signal D(t) with the critical voltage of +1 volt to generate the output signal E₁[n] of 0. The third comparator 1513 compares the data signal D(t) with the critical voltage of −1 volt to generate the output signal E₋₁[n] of 1. The fourth comparator 1514 compares the data signal D(t) with the critical voltage of −3 volt to generate an output signal E₋₃[n] of 1. Then, the output signals, E₃[n], E₁[n], E₋₁[n] and E₋₃[n], form an error information E_{3,1,-1,-3}[n] of 0011. The comparison methods of the other data signals D (t) can be deduced in the same way and will not be described again here.

In some embodiments, the second-layer comparator structure 151 includes a fifth comparator 1521, a sixth comparator 1522 and a seventh comparator 1523. The second input terminal, such as the negative input terminal, of the fifth comparator 1521 is coupled to the output terminal of the first comparator 1511, and the first input terminal, such as the positive input terminal, of the fifth comparator 1521 is coupled to the output terminal of the second comparator 1512 for comparing the reset speeds of the first comparator 1511 and the second comparator 1512. The second input terminal, the negative input terminal, of the sixth comparator 1522 is coupled to the output terminal of the second comparator 1512 and the first input terminal, the positive input terminal, of the sixth comparator 1522 is coupled to the output terminal of the third comparator 1513 for comparing the reset speeds of the second comparator 1512 and the third comparator 1513. The second input terminal, the negative input terminal, of the seventh comparator 1523 is coupled to the output terminal of the third comparator 1513 and the first input terminal, the positive input terminal, of the seventh comparator 1523 is coupled to the output terminal of the fourth comparator 1514 for comparing the reset speeds of the third comparator 1513 and the fourth comparator 1514. In one embodiment, if the input voltage compared by a comparator is closer to the set critical voltage, the reset speed of this comparator will be slower. Therefore, the second-layer comparator structure 152 compares the data signal D(t) with the corresponding comparator critical voltage to determine the reset speed of each comparator in the first-layer comparator structure 151 to generate the data information of T_{2,0,-2}[n] of the data signal D(t).

In one embodiment, if the voltage of the data signal D(t) is closest to +3 volt, because the critical voltage of the first comparator 1511 is +3 volt, the reset speed of the first comparator 1511 is the slowest. The critical voltage of the fourth comparator 1514 is −3 volt, so the reset speed of the fourth comparator 1514 is the fastest. Accordingly, if the voltage of the data signal D(t) is closest to +3 volt, the reset speed of the comparators from slow to fast is the first comparator 1511, the second comparator 1512, the third comparator 1513 and the fourth comparator 1514. Because the reset speed of the second comparator 1512 is greater than that of the first comparator 1511, the fifth comparator 1521 will generate an output signal T₂[n] of 1 representing fast. Because the reset speed of the third comparator 1513 is greater than that of the second comparator 1512, the sixth comparator 1522 will generate an output signal T₀[n] of 1 representing fast. Because the reset speed of the fourth comparator 1514 is greater than that of the third comparator 1513, the seventh comparator 1523 will generate an output signal T₋₂[n] of 1 representing fast. The output signals, T₂[n], T₁[n] and T₋₂[n], form the data information of T_{2,0,-2}[n] of the data signal D(t) of 111. Accordingly, the decoder 170 can decode the data information 111 to generate a binary code 11 carried by the data signal D(t).

In another embodiment, if the voltage of the data signal D(t) is closest to +1 volt and is greater than +1 volt, because the critical voltage of the second comparator 1512 is +1 volt, the reset speed of the second comparator 1512 is the slowest. Moreover, because the voltage of the data signal D(t) is greater than +1 volt, the reset speed of the first comparator 1511 is faster than that of the second comparator 1512. The critical voltage of the fourth comparator 1514 is −3 volt. Therefore, the reset speed of the fourth comparator 1514 is the fastest. Accordingly, if the voltage of the data signal D(t) is closest to +1 volt and is greater than +1 volt, the reset speed of the comparators from slow to fast is the second comparator 1512, the first comparator 1511, the third comparator 1513 and the fourth comparator 1514. Because the reset speed of the second comparator 1512 is slower than that of the first comparator 1511, the fifth comparator 1521 will generate an output signal T₂[n] of 0 representing slow. Because the reset speed of the third comparator 1513 is greater than that of the second comparator 1512, the sixth comparator 1522 will generate an output signal T₀[n] of 1 representing fast. Because the reset speed of the fourth comparator 1514 is greater than that of the third comparator 1513, the seventh comparator 1523 will generate an output signal T₋₂[n] of 1 representing fast. Then, the output signals, T₂[n], T₁[n] and T₋₂[n], form the data information of T_{2,0,-2}[n] of the data signal D(t) of 011. Accordingly, the decoder 170 can decode the data information 011 to generate the binary code 10 carried by the data signal D(t).

The truth table is illustrated in the following.

| | >+3 V | <+3 V | >+1 V | <+1 V | >−1 V | <−1 V | >−3 V | <−3 V |
|---|---|---|---|---|---|---|---|---|
| E₃[n] | +1 | −1 | −1 | −1 | −1 | −1 | −1 | −1 |
| E₁[n] | +1 | +1 | +1 | −1 | −1 | −1 | −1 | −1 |
| E₋₁[n] | +1 | +1 | +1 | +1 | +1 | −1 | −1 | −1 |
| E₋₃[n] | +1 | +1 | +1 | +1 | +1 | +1 | +1 | −1 |
| E_{3, 1, -1,} ₋₃[n] | 1111 | 0111 | 0111 | 0011 | 0011 | 0001 | 0001 | 0000 |
| T₂[n] | S/F | S/F | F/S | F/S | F/S | F/S | F/S | F/S |
| T₀[n] | S/F | S/F | S/F | S/F | F/S | F/S | F/S | F/S |
| T₋₂[n] | S/F | S/F | S/F | S/F | S/F | S/F | F/S | F/S |
| T_{2, 0, -2}[n] | 111 | 111 | 011 | 011 | 001 | 001 | 000 | 000 |
| binary code | 11 | 11 | 10 | 10 | 01 | 01 | 00 | 00 |
| MSB[n]LSB[n] | | | | | | | | |

In a preferred embodiment, the decoder 170 is coupled to the ATPD 150 for decoding the data information T_{2,0,-2}[n] to generate the binary code (MSB[n], LSB[n]) carried by the data signal. In an embodiment, the binary code is the code carried by the PAM-4 signal in the sampling data time. The Boolean function can be expressed as follows:

$$MSB [ n ] = {T}_{0} [ n ] \cdot {T}_{- 2} [ n ]$$

$$LSB [ n ] = ( {T}_{2} [ n ] ⊕ {T}_{0} [ n ] ) ’ \cdot {T}_{- 2} [ n ]$$

The T₂[n] is the output signal generated by the fifth comparator 1521 comparing the reset speeds of the first comparator 1511 and the second comparator 1512. The T₀[n] is the output signal generated by the sixth comparator 1522 comparing the reset speeds of the second comparator 1512 and the third comparator 1513. The T₋₂[n] is the output signal generated by the seventh comparator 1523 comparing the reset speeds of the third comparator 1513 and the fourth comparator 1514.

In another embodiment, the least mean square engine 140 is coupled to the ATPD 150 to correct the critical voltage according to the error information E_{3,1,-1,-3}[n]. That is, the critical voltages of the first comparator 1511, the second comparator 1512, the third comparator 1513 and the fourth comparator 1514 are updated and corrected according to the error information E_{3,1,-1,-3}[n]. The Boolean function to update and correct the critical voltage by the least mean square engine 140 can be expressed as follows:

$$L {V}_{1} [ n + 1 ] = L {V}_{1} [ n ] + μ \cdot {E}_{1} [ n ]$$

$$L {V}_{3} [ n + 1 ] = L {V}_{3} [ n ] + μ \cdot {E}_{3} [ n ]$$

$${LV}_{- 1} [ n + 1 ] = L {V}_{- 1} [ n ] + μ \cdot {E}_{- 1} [ n ]$$

$${LV}_{- 3} [ n + 1 ] = L {V}_{- 3} [ n ] + μ \cdot {E}_{- 3} [ n ]$$

The LV₁[n], LV₃[n], LV₋₁[n] and LV₋₃[n] are the critical voltages of the first comparator 1511, the second comparator 1512, the third comparator 1513 and the fourth comparator 1514 respectively before updating. The LV₁[n+1], LV₃[n+1], LV₋₁[n+1], and LV₋₃[n+1] are the critical voltages of the first comparator 1511, the second comparator 1512, the third comparator 1513 and the fourth comparator 1514 respectively after updating. u is the weight size for updating the critical voltages. The E₁[n], E₃[n], E₋₁[n] and E₋₃[n] are the output signals generated by comparing the data signal D(t) with the LV₁[n], LV₃[n], LV₋₁[n] and LV₋₃ of the first comparator 1511, the second comparator 1512, the third comparator 1513 and the fourth comparator 1514 respectively. Accordingly, after the ATPD 150 generates the error information E_{3,1,-1,-3}[n], the critical voltages of each comparator in the first-layer comparator structure 151 of the ATPD 150 is updated and corrected to avoid critical voltage deviation.

The data recovery circuit 160 is coupled to the ATPD 150 to correct the phase and frequency of the clock signal according to the error information E_{3,1,-1,-3}[n]. the Boolean function to correct the phase and frequency of the clock signal by the data recovery circuit 160 can be expressed as follows:

$$D [ n ] = {MSB [ n - 1 ]}^{′} \cdot MSB [ n ] + ( MSB [ n - 1 ] ⊕ MSB [ n ] ) ’ \cdot {LSB [ n - 1 ]}^{′} \cdot LSB [ n ]$$

$$D [ n - 1 ] = MSB [ n - 1 ] \cdot {MSB [ n ]}^{′} + ( MSB [ n - 1 ] ⊕ MSB [ n ] ) ’ \cdot LSB [ n - 1 ] \cdot {LSB [ n ]}^{′}$$

$$UP [ n ] = {D [ n - 1 ]}^{′} \cdot D [ n ] \cdot E [ n - 1 ] \cdot E [ n ] + D [ n - 1 ] \cdot {D [ n ]}^{′} \cdot {E [ n - 1 ]}^{′} \cdot {E [ n ]}^{′}$$

$$DN [ n ] = {D [ n - 1 ]}^{′} \cdot D [ n ] \cdot {E [ n - 1 ]}^{′} \cdot {E [ n ]}^{′} + D [ n - 1 ] \cdot {D [ n ]}^{′} \cdot E [ n - 1 ] \cdot E [ n ]$$

The MSB[n] and LSB[n] are the binary codes carried by the instant PAM-4 modulation signal. The MSB[n−1] and LSB[n−1] are binary codes carried by the previous PAM-4 modulation signal. The E [n−1] and E [n] are the output signals generated by comparing the data signal D(t) with the critical voltages of the first comparator 1511, the second comparator 1512, the third comparator 1513 and the fourth comparator 1514 respectively. Accordingly, the data recovery circuit 160 corrects the phase and frequency of the output clock signal based on UP[n] and DN[n] which determine whether the clock phase is leading or lagging.

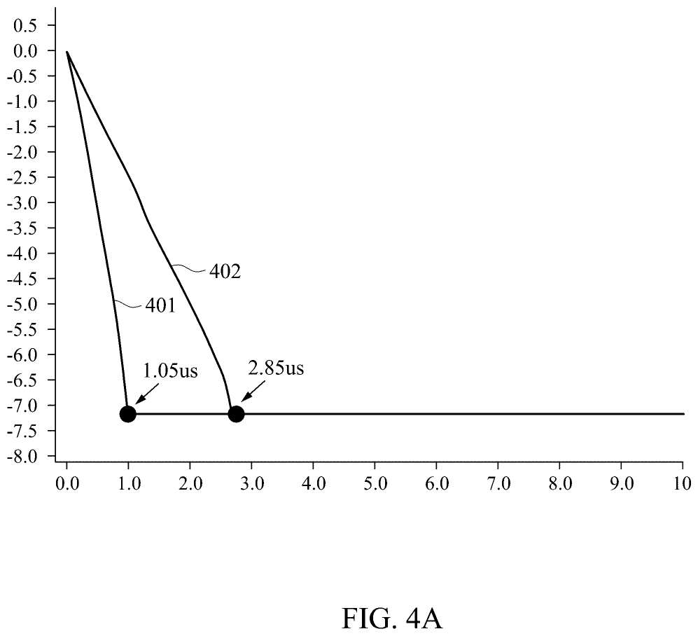

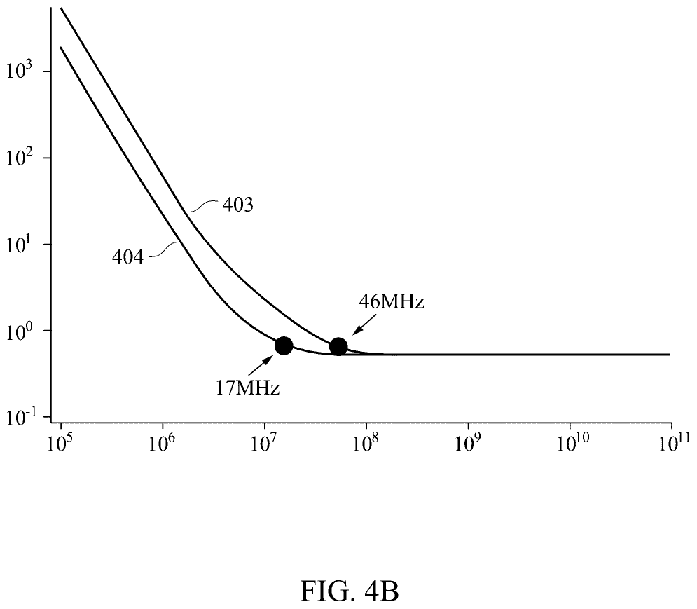

FIG. 4A illustrates a comparison diagram of frequency locking speed between a pulse amplitude modulation receiving device using the ATPD of the present invention and a pulse amplitude modulation receiving device using a conventional phase detector. As shown in FIG. 4A, under the condition of a clock frequency of 14 GHz and a frequency offset of 100 MHz, the frequency locking speed of the pulse amplitude modulation receiving device using the ATPD of this present application, represented by curve 401, is 2.7 times faster than that of the traditional receiving device, represented by curve 402.

FIG. 4B illustrates a comparison diagram of the noise tolerance bandwidth between a pulse amplitude modulation receiving device using the ATPD of the present invention and a pulse amplitude modulation receiving device using a conventional phase detector. As shown in FIG. 4B, under the condition of a clock frequency of 14 GHz and a frequency offset of 100 MHz, the noise tolerance bandwidth of the pulse amplitude modulation receiving device using the ATPD of this present application, represented by curve 403, is improved by 2.7 times compared with the noise tolerance bandwidth of traditional receiving devices, represented by curve 404.

The above-mentioned embodiment uses the PAM-4 signal receiving device 100 as an example to illustrate the ATPD of this present application. However, it is worth noting that the ATPD of this present application can also be applied to other type of multi-level PAM receiving device, for example, PAM-2 signal receiving devices, PAM-3 signal receiving devices, PAM-5 signal receiving devices, PAM-6 signal receiving devices, PAM-8 signal receiving devices, etc. Furthermore, the ATPD of this present application can also be applied to full rate, half rate, quarter rate, or other time-interleaved multi-path multi-level PAM receiving device.

Based on the descriptions above, the present disclosure provides an all transition phase detector (ATPD) for a multi-level PAM signal receiving device. The ATPD includes a two-layer comparator structure, in which the first-layer of the two-layer comparator structure performs voltage level comparison to compare the multi-level PAM signal with the critical voltage level. The second layer of the two-layer comparator structure performs reset speed comparison to compare the reset speed of each comparator in the first layer of the two-layer comparator structure for decoding the signal, adjusting the coefficient of the equalizer, and tracking the signal level. Accordingly, the load effect of the two-layer demodulation structure in this present application is 4×. Compared with the traditional four-bit pulse amplitude modulation demodulator, the load effect on the front-end circuit of the receiving device is reduced to 57%.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A multi-level pulse amplitude modulation (PAM) signal receiving device, comprising:
an all transition phase detector (ATPD) to receive a data signal, wherein the all transition phase detector further comprises:
a first-layer comparator structure, wherein the first-layer comparator structure compares the data signal with critical voltages of the first-layer comparator structure to generate an error information; and
a second-layer comparator structure is connected to the first-layer comparator structure in series, wherein the second-layer comparator structure compares reset speeds of the first-layer comparator structure to generate a data information;
a decoder coupled to the all transition phase detector for decoding the data information to generate a binary code; and
a least mean square engine coupled to the all transition phase detector for updating the critical voltages based on the error information.

2. The multi-level pulse amplitude modulation signal receiving device of claim 1, wherein the critical voltages include a first critical voltage, a second critical voltage, a third critical voltage and a fourth critical voltage, wherein the first-layer comparator structure further comprises:
a first comparator, wherein a first input terminal of the first comparator receives the data signal, and a second input terminal of the first comparator receives the first critical voltage;
a second comparator, wherein a first input terminal of the second comparator receives the data signal, and a second input terminal of the second comparator receives the second critical voltage;
a third comparator, wherein a first input terminal of the third comparator receives the data signal, and a second input terminal of the third comparator receives the third critical voltage; and
a fourth comparator, wherein a first input terminal of the fourth comparator receives the data signal, and a second input terminal of the fourth comparator receives the fourth critical voltage.

3. The multi-level pulse amplitude modulation signal receiving device of claim 2, wherein the first critical voltage is +3 volts, the second critical voltage is +1 volt, the third critical voltage is −1 volt and the fourth threshold voltage is −3 volts.

4. The multi-level pulse amplitude modulation signal receiving device of claim 3, wherein the second-layer comparator structure further comprises:
a fifth comparator, wherein a first input terminal of the fifth comparator is coupled to an output terminal of the second comparator, and a second input terminal of the fifth comparator is coupled to an output terminal of the first comparator, wherein the fifth comparator compares reset speeds of the first comparator and the second comparator;
a sixth comparator, wherein a first input terminal of the sixth comparator is coupled to an output terminal of the third comparator, and a second input terminal of the sixth comparator is coupled to an output terminal of the second comparator, wherein the sixth comparator compares reset speeds of the second comparator and the third comparator; and
a seventh comparator, wherein a first input terminal of the seventh comparator is coupled to an output terminal of the fourth comparator, and a second input terminal of the seventh comparator is coupled to an output terminal of the third comparator, wherein the seven comparator compares reset speeds of the third comparator and the fourth comparator.

5. The multi-level pulse amplitude modulation signal receiving device of claim 4, wherein the multi-level pulse amplitude modulation signal receiving device is a PAM-4 signal receiving device.

6. The multi-level pulse amplitude modulation signal receiving device of claim 4, wherein Boolean function of the binary code generated by the decoder decoding the data information is
$$MSB [ n ] = {T}_{0} [ n ] \cdot {T}_{- 2} [ n ]$$
$$LSB [ n ] = ( {T}_{2} [ n ] ⊕ {T}_{0} [ n ] ) ’ \cdot {T}_{- 2} [ n ]$$
wherein the T₂[n] is an output signal generated by the fifth comparator comparing the reset speeds of the first comparator and the second comparator, the T₀[n] is an output signal generated by the sixth comparator comparing the reset speeds of the second comparator and the third comparator, and the T₋₂[n] is an output signal generated by the seventh comparator comparing the reset speeds of the third comparator and the fourth comparator.

7. An all transition phase detector (ATPD) installed in a multi-level pulse amplitude modulation signal receiving device, comprising:
a first-layer comparator structure, wherein the first-layer comparator structure compares a multi-level pulse amplitude modulation signal with critical voltages of a plurality of comparators in the first-layer comparator structure to generate an error information; and
a second-layer comparator structure is connected to the first-layer comparator structure in series, wherein the second-layer comparator structure compares reset speeds of the comparators in the first-layer comparator structure to generate a data information;
wherein the data information includes a binary code carried by the multi-level pulse amplitude modulation signal, and the error information is used to correct the critical voltages of the plurality of comparators.

8. The all transition phase detector of claim 7, wherein the critical voltages include a first critical voltage, a second critical voltage, a third critical voltage and a fourth critical voltage, wherein the comparators in the first-layer comparator structure further comprises:
a first comparator, wherein a first input terminal of the first comparator receives the multi-level pulse amplitude modulation signal, and a second input terminal of the first comparator receives the first critical voltage;
a second comparator, wherein a first input terminal of the second comparator receives the multi-level pulse amplitude modulation signal, and a second input terminal of the second comparator receives the second critical voltage;
a third comparator, wherein a first input terminal of the third comparator receives the multi-level pulse amplitude modulation signal, and a second input terminal of the third comparator receives the third critical voltage; and
a fourth comparator, wherein a first input terminal of the fourth comparator receives the multi-level pulse amplitude modulation signal, and a second input terminal of the fourth comparator receives the fourth critical voltage.

9. The all transition phase detector of claim 8, wherein the first critical voltage is +3 volts, the second critical voltage is +1 volt, the third critical voltage is −1 volt and the fourth threshold voltage is −3 volts.

10. The all transition phase detector of claim 9, wherein the second-layer comparator structure further comprises:
a fifth comparator, wherein a first input terminal of the fifth comparator is coupled to an output terminal of the second comparator, and a second input terminal of the fifth comparator is coupled to an output terminal of the first comparator, wherein the fifth comparator compares reset speeds of the first comparator and the second comparator;
a sixth comparator, wherein a first input terminal of the sixth comparator is coupled to an output terminal of the third comparator, and a second input terminal of the sixth comparator is coupled to an output terminal of the second comparator, wherein the sixth comparator compares reset speeds of the second comparator and the third comparator; and
a seventh comparator, wherein a first input terminal of the seventh comparator is coupled to an output terminal of the fourth comparator, and a second input terminal of the seventh comparator is coupled to an output terminal of the third comparator, wherein the seventh comparator compares reset speeds of the third comparator and the fourth comparator.

11. The all transition phase detector of claim 10, wherein the multi-level pulse amplitude modulation signal receiving device is a PAM-4 signal receiving device.

12. The all transition phase detector of claim 11, wherein a decoder is coupled to the all transition phase detector for decoding the data information to generate a binary code carried by the multi-level pulse amplitude modulation signal.

13. The all transition phase detector of claim 12, wherein Boolean function of the binary code generated by the decoder decoding the data information is
$$MSB [ n ] = {T}_{0} [ n ] \cdot {T}_{- 2} [ n ]$$
$$LSB [ n ] = ( {T}_{2} [ n ] ⊕ {T}_{0} [ n ] ) ’ \cdot {T}_{- 2} [ n ]$$
wherein the T₂[n] is an output signal generated by the fifth comparator comparing the reset speeds of the first comparator and the second comparator, the T₀[n] is an output signal generated by the sixth comparator comparing the reset speeds of the second comparator and the third comparator, and the T₋₂[n] is an output signal generated by the seventh comparator comparing the reset speeds of the third comparator and the fourth comparator.

14. The all transition phase detector of claim 13, wherein a least mean square engine is coupled to the all transition phase detector for updating the critical voltages of the comparators based on the error information.

15. The all transition phase detector of claim 14, wherein Boolean function for correcting the critical voltages of the comparators by the least mean square engine is
$$L {V}_{1} [ n + 1 ] = L {V}_{1} [ n ] + μ \cdot {E}_{1} [ n ]$$
$$L {V}_{3} [ n + 1 ] = L {V}_{3} [ n ] + μ \cdot {E}_{3} [ n ]$$
$${LV}_{- 1} [ n + 1 ] = L {V}_{- 1} [ n ] + μ \cdot {E}_{- 1} [ n ]$$
$${LV}_{- 3} [ n + 1 ] = L {V}_{- 3} [ n ] + μ \cdot {E}_{- 3} [ n ]$$
wherein the LV₁[n], the LV₃[n], the LV₋₁[n] and the LV₋₃[n] are the critical voltages of the first comparator, the second comparator, the third comparator and the fourth comparator respectively before updating;
the LV₁[n+1], the LV₃[n+1], the LV₋₁[n+1], and the LV₋₃[n+1] are the critical voltages of the first comparator, the second comparator, the third comparator and the fourth comparator respectively after updating;
μ is a weight for updating the critical voltages; and
the E₁[n], the E₃[n], the E₋₁[n] and the E₋₃[n] are output signals generated by comparing the multi-level pulse amplitude modulation signal with the LV₁[n], the LV₃[n], the LV₋₁[n] and the LV₋₃[n] of the first comparator, the second comparator, the third comparator and the fourth comparator respectively.
